(19) United States
(12) Patent Application Publication
(10) Pub. No.: US 2014/0042737 A1
(43) Pub. Date: Feb. 13, 2014

(54) CONTAINER LABELS AND METHOD OF MATCHING

(71) Applicant: Valerie Joseph, (US)

(72) Inventor: Valerie Joseph, (US)

(21) Appl. No.: 13/568,167

(22) Filed: Aug. 7, 2012

(51) Int. Cl. B42D 15/00

(52) U.S. Cl. 283/70; 283/81

(57) ABSTRACT

A matching apparatus which may be used for matching lids and receptacles of containers is provided with label pairs, adhesive layers and a base portion. Label pairs include at least two individual labels, removably adhered to the base portion. Each label in the pair has a viewable surface with a graphic and the graphics of each pair are correlated. Also provided is a method of matching lids to corresponding receptacles using the label pairs.

### I. BACKGROUND

A. Field of Invention

This invention generally relates to methods and apparatuses for matching lids to corresponding receptacles.

B. Description of the Related Art

It is well known in the art to provide matching lids and receptacles which when mated form a sealed storage container. There are innumerable uses for such storage containers and the household kitchen is a common usage area. Examples of storage container uses include storing dry food goods, cooked food items, and spices.

A known problem with storage containers is it becomes a difficult task to maintain an organized collection of lids and corresponding receptacles. This task's difficulty increases when the collection of storage containers includes a variety of sizes and shapes. The organizational task is further complicated if storage containers by various manufactures is incorporated. In this case lids from one manufacturer and receptacles from a different manufacturer may be very close in size and shape but will not correctly fit one another. When this situation is encountered the user often must resort to a time consuming trial and error approach to matching lids and receptacles.

One known attempted solution to this problem is to mark lids and corresponding receptacles individually using an ink marker. The user may choose to mark said containers with hand drawn graphic images or some relevant text. If the same marking is put on corresponding lids and receptacles then the user can match the corresponding parts by matching the markings. One problem with this method is the markings tend to come off through wear or through cleaning the container in a dishwasher. A second problem with this method is the markings applied by the user may not be cosmetically attractive.

Another known attempted solution to this problem is to purchase adhesive labels that display graphic images or some relevant text. These labels can be applied to lids and corresponding receptacles individually. Using these labels the user can match the corresponding lids and receptacles by matching the images on the applied labels. A problem with this method is commercially available labels come in lots or groups with all labels displaying the same image. Using labels to match lids and receptacles when one has a large collection of storage containers that includes a variety sizes and shapes requires a large number of pairs of labels. In order to have enough pairs of labels with differing images, the user must purchase a large quantity of different lots of labels. Having many lots of labels obviously leads to having an even larger total number of labels. Thus this method burdens the user with an unnecessarily large cost to purchase all those labels. Also storing the large numbers of labels takes up valuable storage place and organizing the labels can be time consuming.

Another known attempted solution to this problem is to maintain a very narrow collection of storage containers limited in size, shape, and manufacturer. In this case the time consumed by trial and error matching of lids and receptacles is minimized. A problem with this solution is that, by its very nature, it limits the sizes and shapes of storage containers available to the user. This limitation reduces the utility value storage containers offer the user.

What is needed is a method and apparatus for matching lids and receptacles which is easy to use, is not time consuming, is permanent or semi-permanent, cosmetically attractive, economically attractive, and does not limit the user's choice of storage containers.

### II. SUMMARY

According to one embodiment of this invention, a matching apparatus may comprise a label pair that comprises at least two labels wherein each label has a viewable surface and the viewable surface has a graphic, and the graphic of each pair are correlated; at least two adhesive layers; and a base portion; wherein the adhesive layers are positioned between the base portion and the labels, each label is removable adhered to the base portion, and each label is oriented in such a manner that viewable surface is clearly visible.

According to another embodiment of this invention, a matching apparatus may comprise a plurality of label pairs that comprises at least two labels wherein each label has a viewable surface and the viewable surface has a graphic, and the graphic of each pair are correlated; a plurality of adhesive layers; and a base portion; wherein the adhesive layers are positioned between the base portion and the labels, each label is removable adhered to the base portion, each label is oriented in such a manner that viewable surface is clearly visible, the plurality of label pairs are positioned in a plurality horizontal rows with correlated labels being adjacent; and the plurality of horizontal rows extend vertically.

According to yet another embodiment of this invention, a matching apparatus may comprise a plurality of label pairs that comprises at least two labels wherein each label has a viewable surface and the viewable surface has a graphic, and the graphic of each pair are correlated; a plurality of adhesive layers; and abuse portion; wherein the adhesive layers are positioned between the base portion and the labels, each label is removable adhered to the base portion, each label is oriented in such a manner that viewable surface is clearly visible, the plurality of label pairs are positioned in a horizontal row with correlated labels being adjacent.

According to yet another embodiment of this invention, a method of matching lids and receptacles may comprise the steps of (A) providing a collection of storage containers: (B) selecting a first article from the collection; (C) noting the graphic viewable on the first article; (D) visually inspecting the remaining articles in the collection until a correlated graphic is found on the second article; and, (E) mating first and second article.

One advantage of this invention is that lids and receptacles can be easily matched without consuming a large amount of time, and done so in an economical manner.

Another advantage of this invention is that it provides a permanent or a semi-permanent method which allows the user to organizing lids and receptacles.

Yet another advantage of this invention is that it provides a cosmetically attractive way to organize lids and receptacles which may be harmonized with the user's decor.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a front view of a matching apparatus containing a label pair.

FIG. 2 is an end sectional view of a matching apparatus containing a label pair.

FIG. 3 is a front view of a matching apparatus containing a plurality of label pairs arranged in a plurality of rows.

FIG. 4 is a front view of a matching apparatus containing a plurality of label pairs arranged in a single row.

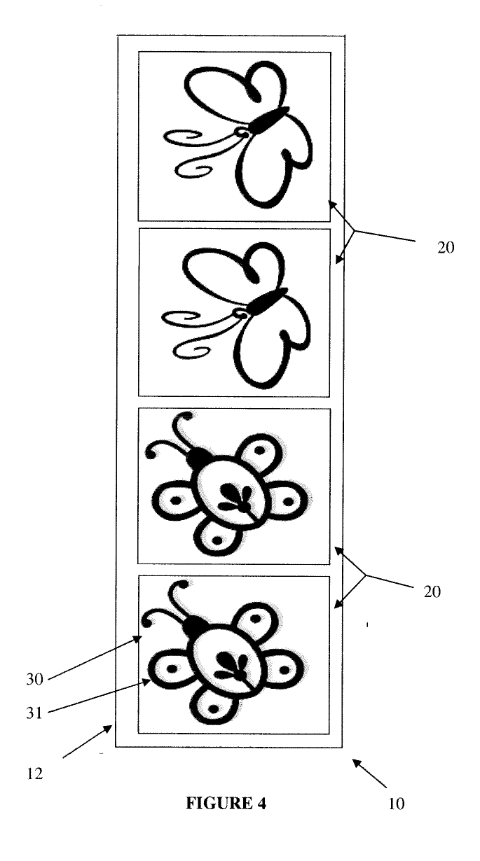

FIG. 5 is exploded perspective view of a storage container with a label pair in place.

### IV. DETAILED DESCRIPTION

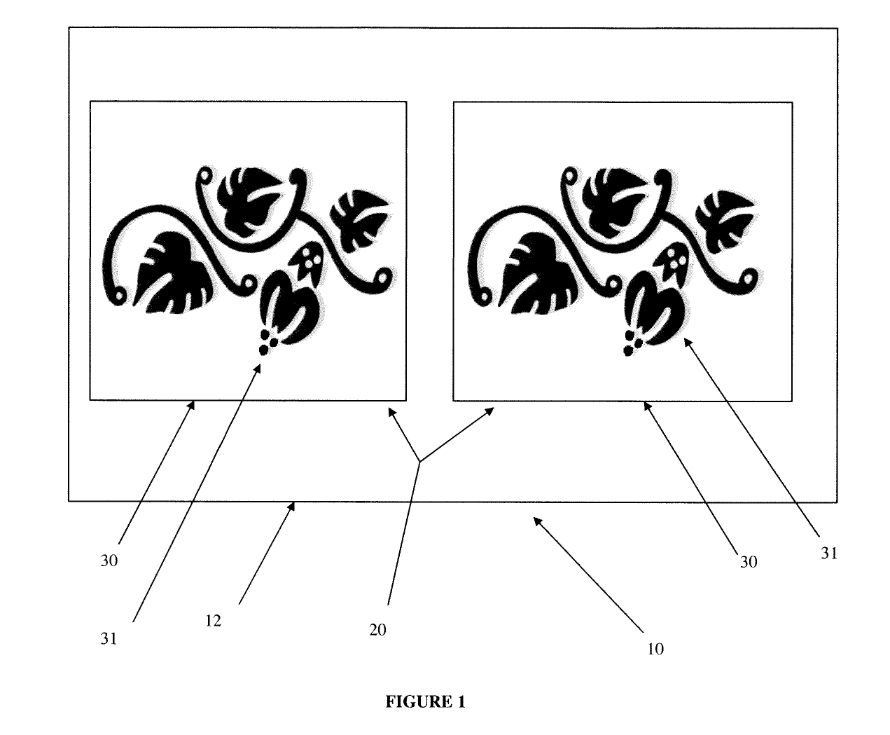

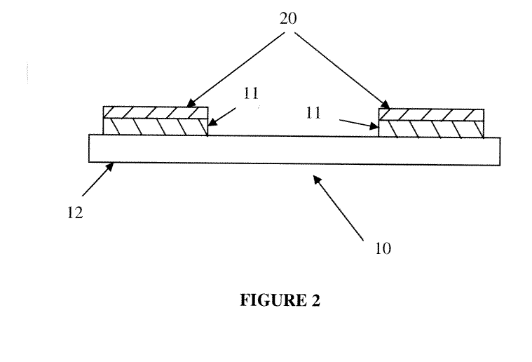

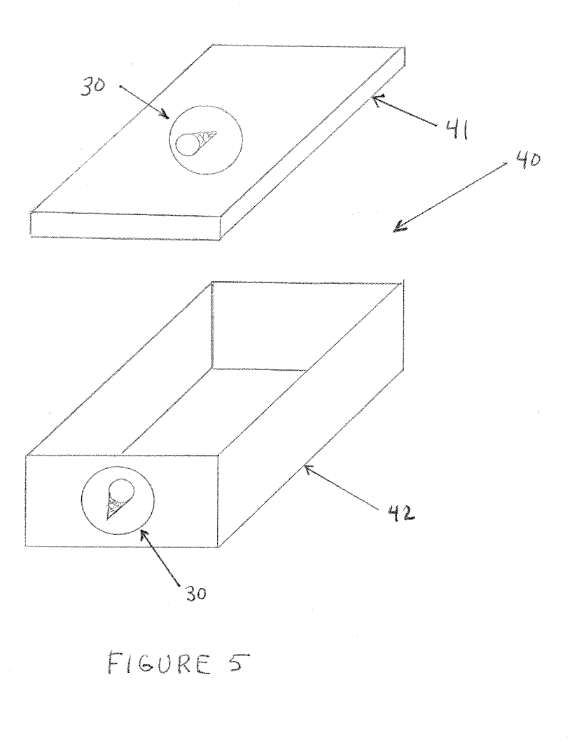

Referring now to the drawings wherein the showings are for purposes of illustrating embodiments of the invention only and not for purposes of limiting the same, and wherein like reference numerals are understood to refer to like components, FIG. 1 shows an matching apparatus 10. The matching apparatus 10 may comprise a label pair 20, at least two adhesive interfaces 11, and a base portion 12. The label pair 20 may be provided to the user on base portion 12. Between label pair 20 and base portion 12 are at least two adhesive interfaces 11 as shown in FIG. 2. Label pair 20 may be removably adhered to base portion 12. In one non-limiting example of removal, label pair 20 may be separated from the base portion 12 by peeling the two elements apart. After separating the two elements, label pair 20 may retain adhesive from adhesive interface 11. This adhesive may allow label pair 20 to be permanently or semi-permanently secured to a storage container 40, see FIG. 5. This adhesive may also allow label pair 20 to remain secured to a storage container 40 once the storage container 40 is subjected to the rigors of a dishwasher cleaning process. The rigors of a dishwasher are well known to those of skill in the art. non-limiting examples of these rigors are the combination of the 180 degree water and the strong detergent used to clean. the heater that comes on to dry at the during the dishwasher cycle, and the intense bottom rack heat used in a dishwasher. Another rigor encountered in the dishwasher is water squirting around during the cleaning process. The water may strike an item inside the dishwasher with enough force to damage it. Materials that compose matching apparatus 10 may be chosen with the sound judgment of a person of skill in the art.

Once again referring to FIG. 1, label pair 20 may include a plurality of individual labels 30. Label 30 may have a viewable surface and an opposing surface. Label 30 may include graphic 31 located on its viewable surface. The graphics 31 included in label pair 20 may be correlated. It is to be understood that correlated graphics means the graphics 31 are substantially similar, easily. identifiable, or related in a logical way. Also graphic 31 may be of a decorative nature. Non-limiting examples of graphic 31 are depictions of butterflies, lady bugs, daisies, and buttercup flowers. Other non-limiting examples of graphic 31 may include depictions of types of fruit and vegetables, kitchen utensils, dishes, bowls, and various other kitchen related items that would complement the user's household decorating scheme. In another group of non-limiting examples, graphic 31 may take the form of text such as slogans, mottos, proverbs, or names. Graphic 31 may also be composed of combinations of the before mentioned examples. The color, font, style, and outline shape that comprise graphic 31 may complement the user's household decorating scheme. Label 30 may be composed of materials and constructed in such a manner that it will impervious to water and thus withstand being subjected to water repeatedly. Also label 30 may be composed of materials and constructed in such a manner that it will withstand the rigors of a dishwasher cleaning process. Materials that compose matching apparatus 10 may be chosen with the sound judgment of a person of skill in the art.

In one embodiment, shown in FIG. 1, matching apparatus 10 may include a label pair 20, at least two adhesive interfaces 11, and a base portion 12. The label pair 20 may be provided to the user on base portion 12 with the viewable surface of label 30 visible to the user.

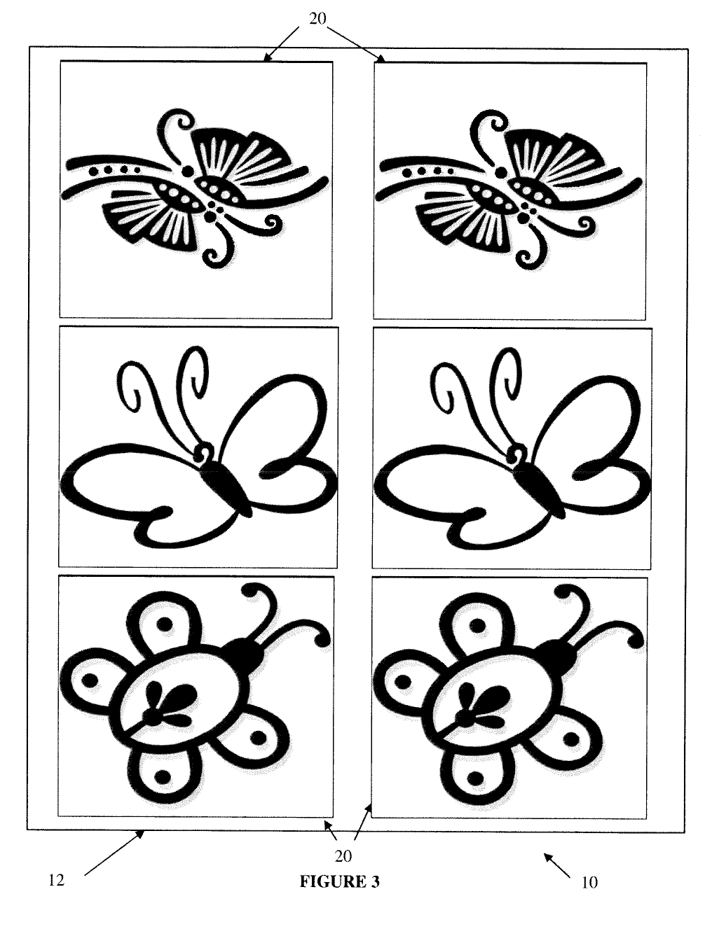

In another embodiment, shown in FIG. 3, matching apparatus 10 may include a plurality of label pairs 20, a plurality of adhesive interfaces 11, and a base portion 12. A plurality of label pairs 20 may be provided to the user on base portion 12 with the viewable surface of label 30 visible to the user. A plurality of label pairs 20 may be provided in a plurality of horizontal rows located such that individual labels 30 with correlated graphics 31 are adjacent. The pluralities of horizontal rows extend vertically down base portion 12.

In another embodiment, matching apparatus 10 may include a plurality of label pairs 20, a plurality of adhesive interfaces 11. and a base portion 12. A plurality of label pairs 20 may be provided to the user on base portion 12 with the viewable surface of label 30 visible to the user. A plurality of label pairs 20 may be provided in a row with individual labels 30 oriented such that labels 30 with correlated graphics 31 are adjacent.

In another embodiment, matching apparatus 10 may be constructed in such a manner and composed of such materials that matching apparatus 10 is compatible with electronic printing devices. Non-limiting examples of electronic printing devices include laser printers, liquid ink printers, and solid ink printers. Materials that compose matching apparatus 10 may be chosen with the sound judgment of a person of skill in the art.

The following method may be followed when a user desires to secure the matching apparatus 10 to storage container 40 for future identification and matching. First, a storage container 40 may be provided with lid 41 and mating receptacle 42. Next a label pair 20 may be selected. When selecting a label pair 20, the user may wish to consider decorative elements of the label pair 20 and choose a pair in harmony with the user's decorative scheme. Then an individual label 30 from the chosen pair may be separated from the base portion 12. Next, the separated label 30 may be placed on the lid 41 in such a manner that graphic 31 is clearly visible to the user. Label 30 may be pressed down and securely adhered to the lid 41. Following, the remaining label 30 from the chosen label pair 20 may be separated from the base portion 12. The remaining label 30 may be placed on the mating receptacle 42 in such a manner that graphic 31 is clearly visible to the user. In a similar manner, remaining label 30 may then be securely adhered to mating receptacle 42. This method may also be followed by altering the order such that a label 30 is placed on the receptacle 42 first and secondarily a label 30 is placed on a lid 41.

The following method may be followed when a user desires to sort and mate lids 41 and corresponding receptacles 42 from a collection. A collection means a plurality of storage containers 40 of various shapes and sizes, the lids and receptacles contained in the collection do not all mate interchangeably, but contained within the collection is at least one lid and corresponding receptacle which do mate. Furthermore, the collection has at one time been sorted so that lids and corresponding receptacles have been marked with a label pair 20 in the manner previously described but at the present time the collection consists of unmated lids 41 and receptacles 42. Lastly, all label pairs 20 in the collection are unique, thus no duplicate label pairs exist in the collection. First step in the method, the user may select a first article from the collection; an article may be either a lid 41 or a receptacle 42. Then the user notes the graphic 31 on first article. Next the user may go through the collection comparing each of the remaining articles' graphic 31 with the graphic 31 on the first article. Once a second article is found with a correlated graphic 31 matching the graphic 31 on the first article, the user may mate the articles. This method will result in a mated lid 41 and corresponding receptacle 42.

Numerous embodiments have been described, hereinabove. Other uses of the invention include objects that are not containers but that need to be paired. For example, variations of the idea include using graphics on portable phones and their respective chargers. In a larger household, such as one with teenaged children, each parent will often have a cellular telephone with its own unique charger. The use of the graphics would assist the user in paring the right phone with the right charger. Similarly, for parents with younger children that play with toys with various parts, parts of toys that need to be used together can be identified with the use of the graphics. Another use is the paring of remote control units with the media piece corresponding to it. It is not unusual to have a cable receiver, a Bluetooth® player. a VHS player, a CD player and a tuner all having different remotes and all being housed in a single media center. The use of the graphics can be used to pair the correct remote to the correct device. It will be apparent to those skilled in the art that the above methods and apparatuses and applications may incorporate changes and modifications without departing from the general scope of this invention. It is intended to include all such modifications and alterations in so far as they come within the scope of the appended claims or the equivalents thereof.

Having thus described the invention, it is now claimed:

1. A matching apparatus comprising:
a plurality of label groups comprising;
at least two labels wherein each label has a viewable surface and the viewable surface has a graphic;
wherein the graphics of each label group are correlated;
a plurality of adhesive layers; and
a base portion;
wherein said adhesive layers are positioned between the base portion and said labels, each label is removably adhered to the base portion, and each label is oriented in such a manner that each viewable surface is clearly visible;
wherein the plurality of label groups and the plurality of adhesive layers are impervious to water and are able to withstand a dishwasher process.

2-20. (canceled)

21. The matching apparatus of claim 1, wherein each label group of the plurality of label groups consists of a pair of labels.

22. The matching apparatus of claim 21, wherein:
a first label of a first label group is affixed by the adhesive layer of the first label to a first associated receptacle; and
a second label of the first label group is affixed by the adhesive layer of the second label to a first associated lid corresponding to the first associated receptacle.

23. The matching apparatus of claim 22, wherein:
a third label of a second label group is affixed by the adhesive layer of the third label to a second associated receptacle; and
a fourth label of the second label group is affixed by the adhesive layer of the fourth label to a second associated lid corresponding to the second associated receptacle.

24. The matching apparatus of claim 23, wherein:
the first associated lid does not correspond to the second associated receptacle; and
the second associated lid does not correspond to the first associated receptacle.

25. The matching apparatus of claim 24, wherein:
the first label, the second label, the third label, and the fourth label are affixed permanently or semi-permanently.

26. The matching apparatus of claim 25, wherein the associated receptacle and associated lid make up a kitchen or cooking container.

27. The matching apparatus of claim 25, wherein:
the plurality of label groups is constructed from a material that is compatible with ink-printing onto the plurality of label groups such that the graphics of each label group can be permanently printed onto each label group.

28. A method of matching objects, comprising the steps of:
a) providing:
a plurality of object groups, wherein each object within a group is intended to physically connect to at least one other object within that group;
a plurality of label groups, each group comprising:
at least two labels, wherein each label has a viewable surface that includes a graphic;
wherein the graphics of each label within the group are correlated and unique compared to other label groups;
a plurality of adhesive layers; and
a base portion;
wherein: 1) the adhesive layers are positioned between the base portion and the labels; 2) each label is removably adhered to the base portion; and 3) each label is oriented in such a manner that each viewable surface is clearly visible;
b) securing at least one label of a label group by the adhesive layer to each object of at least one object group, such that all objects in an object group bear labels from the same label group;
c) selecting a first object of a first object group bearing a label;
d) determining the graphic displayed on the first object;
e) visually inspecting the remaining objects in the plurality of object groups to select all other objects displaying a graphic correlated to the graphic displayed on the first object; and
f) connecting the selected objects together.

29. The method of claim 28, wherein:
step c) further comprises selecting a second object of a second object group bearing a label;
step d) further comprises determining the graphic displayed on the second object;
step e) further comprises visually inspecting the remaining objects in the plurality of object groups to select all other objects displaying a graphic correlated to the graphic displayed on the second object; and
step f) comprises 1) connecting the selected objects of the first group together, and 2) connecting the selected objects of the second group together.

30. The method of claim 28, wherein objects of one object group of step a) are not designed to physically connect with objects of other object groups.

31. The method of claim 28, wherein the securing of step b) is permanent or semi-permanent.

32. The method of claim 28, wherein:
each object group of step a) consists of a pair of objects; and
each label group of step a) consists of a pair of labels.

33. The method of claim 32, wherein each pair of objects of step a) consists of a cooking or kitchen receptacle and corresponding lid.

34. The method of claim 33, wherein the plurality of pairs of labels and the plurality of adhesive layers of step a) are impervious to water and are able to withstand a dishwasher process.

35. The method of claim 28, wherein each object group of step a) comprises an electronic device and corresponding power supply or battery charger.

36. The method of claim 28, wherein each object group of step a) comprises a toy.

37. The method of claim 28, wherein:
the plurality of label groups of step a) is constructed from a material that is compatible with ink-printing onto the plurality of label groups such that the graphics of each label group can be permanently printed onto each label group; and
the plurality of label groups and the plurality of adhesive layers of step a) are impervious to water and are able to withstand a dishwasher process.

38. The method of claim 28, further comprising step:
g) disconnecting all objects of the plurality of object groups;
wherein step g) is performed before step c).
